(19) United States
(12) Patent Application Publication
(10) Pub. No.: US 2025/0304473 A1
(43) Pub. Date: Oct. 2, 2025

(54) PHOTOCATALYST ENABLED FLEXIBLE POLYMERIC OPTICAL FIBER SYSTEM

(71) Applicants: Paul K. Westerhoff, Scottsdale, AZ (US); Sergio Garcia-Segura, Tempe, AZ (US); Tzu-Heng Wang, Tainan City (TW)

(72) Inventors: Paul K. Westerhoff, Scottsdale, AZ (US); Sergio Garcia-Segura, Tempe, AZ (US); Tzu-Heng Wang, Tainan City (TW)

(21) Appl. No.: 19/091,557

(22) Filed: Mar. 26, 2025

Related U.S. Application Data
(60) Provisional application No. 63/569,938, filed on Mar. 26, 2024.

(51) Int. Cl. C02F 1/461; B01J 21/06; B01J 23/02; B01J 31/02; B01J 31/06; B01J 35/39; C02F 1/32; C02F 1/467; C02F 101/34; G02B 6/02

(52) U.S. Cl. CPC C02F 1/46109; B01J 21/063; B01J 23/02; B01J 31/0239; B01J 31/06; B01J 35/39; C02F 1/325; C02F 1/4672; G02B 6/02033; C02F 2001/46142; C02F 2001/46171; C02F 2101/34; C02F 2201/3224; C02F 2305/023; C02F 2305/08; C02F 2305/10

(57) ABSTRACT

A coated optical fiber includes a polymeric side-emitting optical fiber, a cladding along a length of the polymeric side-emitting optical fiber, an electrically conductive nanomaterial in contact with the cladding, and a coating over the cladding. The coating includes a photocatalyst.

### CROSS-REFERENCE TO RELATED APPLICATION

This application claims the benefit of U.S. Patent Application No. 63/569,938 filed on Mar. 26, 2024, which is incorporated herein by reference in its entirety.

### STATEMENT OF GOVERNMENT SUPPORT

This invention was made with government support under 1449500 awarded by the National Science Foundation. The government has certain rights in the invention.

### TECHNICAL FIELD

This invention relates to photocatalyst enabled flexible polymeric optical fiber systems.

### BACKGROUND

Hydrogen, as a versatile energy storage and carrier strategy, is a useful component in achieving net-zero emissions due at least in part to its ability to decarbonize a wide array of applications. A photoelectrochemical system combines photovoltaic or photocatalytic processes with electrochemical processes to harness light for water splitting. Photocatalytic hydrogen generation uses catalysts to drive water splitting with light.

### SUMMARY

This disclosure describes a physically flexible catalytic polymeric optical fiber (POF) architecture, called an optoelectrode fiber, embedded with electrically conductive indium tin oxide (ITO) nanomaterials and tris(tetramethylammonium bromide) dibismuth heptabromo diioide (TAB₃Bi₂Br₇I₂) perovskite (ABI) visible-photocatalysts in a Nafion-polyvinylidene fluoride (PVDF) polymer surface layer. The photoelectrochemical (PEC)-POF architecture achieves a surface area more than 6000% larger than flat glass electrodes and over 90% organic pollutant removal in water. It also exhibits more than 300% improvement in incident photon-to-current efficiency than the same ABI-nanomaterial deposited on a well-known ITO-coated flat glass-plate under low energy irradiation. Nanomaterials tunable to specific wavelengths using a light-emitting diode (LED) or polychromatic light sources can be deposited on the POFs. Bundling large numbers of POF optoelectrodes together achieves reactors with orders of magnitude higher packing geometries (e.g., m² of catalyst surface per m³ of reactor volume) than flat-electrode PEC reactors, enabling the optoelectrode fiber to address environmental problems.

This disclosure also describes a photocatalytic hydrogen production system, POF-strontium titanate (STO), by attaching a modified STO onto POFs. Light launched from 365 nm LED into the POF lumen is side-emitted and excites the STO in a porous layer on the POF surface. The inside-out light delivery mechanism with the POF allows efficient photon confinement and energy transfer to the STO surface, maximizing light utilization. The POF-STO system produces stable H₂ production rates in both acidic and alkaline environments, with more than 10% reduction in hydrogen generation when using tap water and seawater.

In a first general aspect, an optical fiber includes a polymeric side-emitting optical fiber, a cladding along a length of the polymeric side-emitting optical fiber, an electrically conductive nanomaterial in contact with the cladding, and a coating over the cladding, wherein the coating includes a photocatalyst.

Implementations of the first general aspect can include one or more of the following features. In some cases, the polymeric side-emitting optical fiber includes an acrylic polymer (e.g., poly(methyl methacrylate)). In some implementations, the cladding includes a fluoropolymer (e.g., polyvinylidene fluoride). The electrically conductive nanomaterial can include indium tin oxide. The indium tin oxide can be in the form of nanoparticles. In some cases, the coating is porous. In one example, the photocatalyst includes a perovskite (e.g., tris(tetramethylammonium bromide) dibismuth heptabromo diioide) (TAB₃Bi₂Br₇I₂ Suitable materials for the photocatalyst can include titania or a modified strontium titanate. In certain implementations, the photocatalyst is embedded in an ionomer (e.g., a sulfonated tetrafluoroethylene based fluoropolymer copolymer)).

In a second general aspect, a reactor includes one or more of the optical fibers of the first general aspect and a light source optically coupled to the one or more of the optical fibers.

Implementations of the second general aspect can include one or more of the following features. In some cases, the light source includes concentrated sunlight, a light-emitting diode, or a laser. The light source can be configured to provide ultraviolet radiation to the one or more optical fibers. In certain implementations, the ultraviolet radiation is selected to photo-induce exciton generation in the photocatalyst.

In a third general aspect, making the optical fiber of the first general aspect includes polishing a polymeric side-emitting optical fiber and coating the polymeric side-emitting optical fiber with a mixture including a photocatalyst.

In a fourth general aspect, treating organic pollutants includes contacting one or more optical fibers of the first general aspect in a reactor with an aqueous solution including an organic pollutant, irradiating a photocatalyst with a light source, and oxidizing the organic pollutant with the reactive oxygen species. Irradiating the photocatalyst with a light source generates reactive oxygen species.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A and 1B show schematic illustrations of an example reactor design with visible light delivered from a light-emitting diode (LED) into a polymeric optical fiber-indium tin oxide/TAB₃Bi₂Br₇I₂ perovskite (POF-ITO/ABI) optoelectrode. FIG. 1C is a schematic diagram of the hydrogen production mechanism via water splitting on the strontium titanate (STO)-coated POF surface.

FIGS. 2A-2C show scanning electron microscopy surface images of uncoated polymeric optical fibers, POF-ITO, and POF-ITO/ABI, respectively.

FIGS. 3A and 3B show optical measurements of bare poly(methyl methacrylate) (PMMA)/polyvinylidene difluoride (PVDF) POF (PMMA/PVDF POF), POF-ITO, POF-ABI, and POF-ITO/ABI. FIG. 3A shows intensity of side-emission efficiency (I_{S}) performance of modified POFs in different mass loading for single nanomaterial coating. FIG. 3B shows light side-emission and light utilization (I_{U}) effects of ABI atop ITO nanomaterial layer (68 μg cm⁻¹) with 395 nm LED light (2.18 W) irradiation.

FIGS. 4A and 4B show electrochemical and photoelectric performance in the pristine POF and integrated optoelectrode fibers. FIG. 4A shows conductive performance by linear sweep voltammetry analyses of bare POF (zero coating layers) and six different POF-ITO produced using multiple coating cycles of 10 mg of ITO per mL in a 0.5 M Na₂SO₄ electrolyte solution at pH 6.8. FIG. 4B shows photoelectrocatalytic stability of bare fiber, POF-ITO, and POF-ITO/ABI (three coating layers) recorded using chronoamperometry with 395 nm LED light (2.18 W) irradiation.

FIG. 5 shows conversion efficiency of uncoated POF and modified POF with nanomaterials. Incident photon-to-current efficiency performance of bare PMMA/PVDF POF, POF-ITO, POF-ITO/ABI, and ABI (9 g L⁻¹)-ITO glass plates are shown.

FIGS. 6A-6D show pseudo-first order rate kinetics comparison of benzoate ion. FIG. 6A shows the effect of different scavengers for benzoate ion in the POF-ITO/ABI under photoelectrocatalysis of k and degradation efficiency after 60 seconds. FIG. 6B compares the rate constants of photoelectrochemical (PEC) degradation with varying LED light power (different light utilization efficiency). FIG. 6C shows the rate constant of PEC degradation as a function of varying current density. FIG. 6D shows variable benzoate ion removal during different catalytic processes.

FIG. 7 is a schematic diagram of the fabrication process of POF-STO.

FIGS. 8A-8C are scanning electron microscopy images of bare POF, etched POF, and POF-STO samples, respectively.

### DETAILED DESCRIPTION

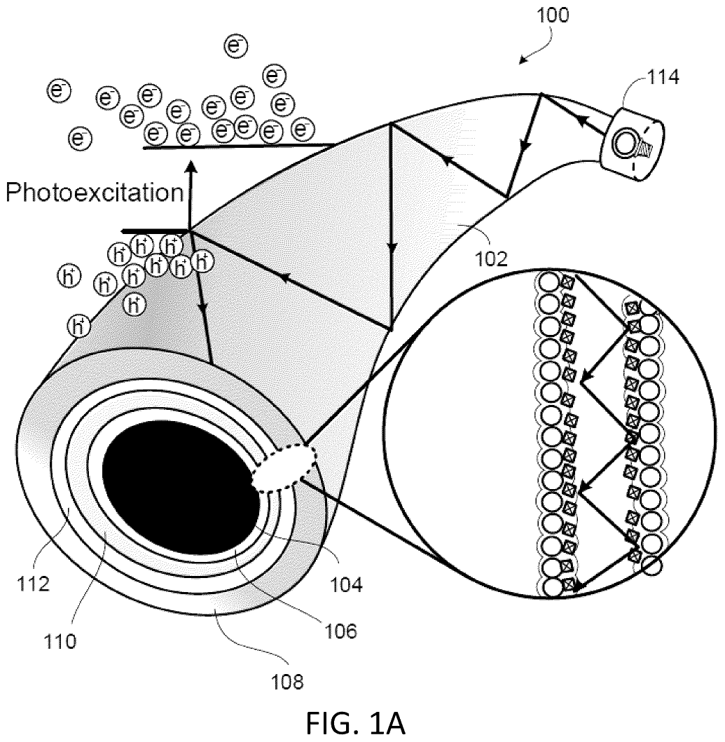

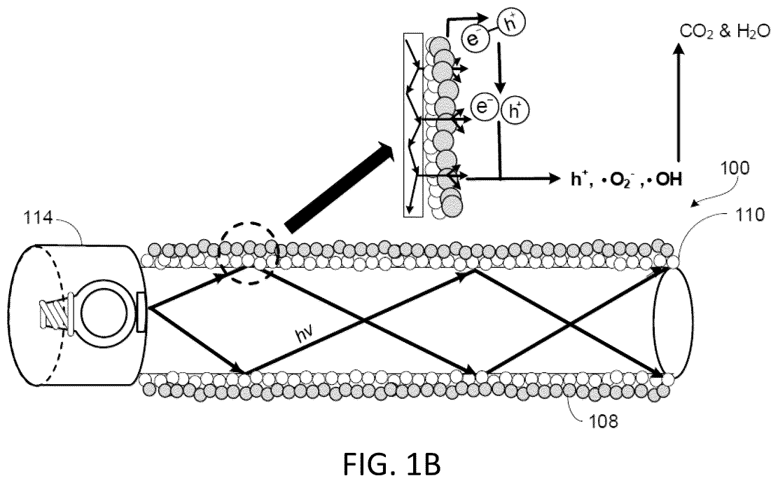

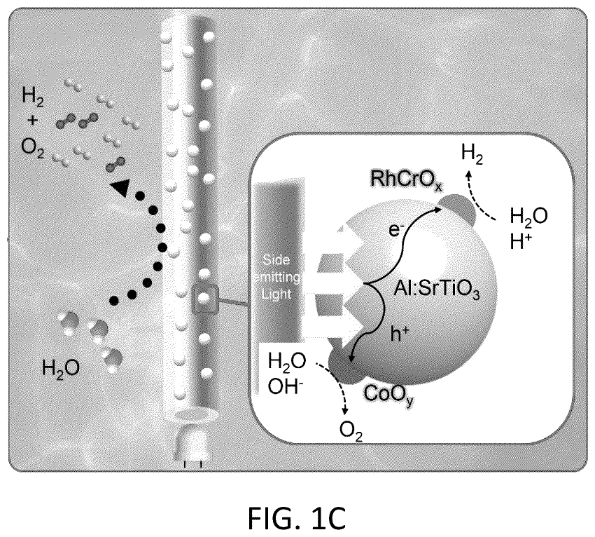

This disclosure describes fabrication and characterization of optoelectrodes having a polymeric core and a porous, conductive polymeric cladding with embedded nanomaterials. One example of a physically flexible catalytic polymeric optical fiber (POF) includes electrically conductive nanomaterials and visible photocatalysts in a polymeric cladding, as shown in FIGS. 1A and 1B. In some cases, poly(methyl methacrylate) (PMMA) POFs are embedded with indium tin oxide nanomaterials and TAB₃Bi₂Br₇I₂ perovskite (ABI) in Nafion®-polyvinylidene fluoride (PVDF) surface layer.

Integrating conductive nanomaterials such as indium tin oxide (ITO) and photoactive nanoparticles on visible light side-emitting optical fibers creates an optoelectrode capable of energy efficient reactions. The optoelectrode can be used as an anode to generate reactive oxidant species capable of degrading organic pollutants in water. The optoelectrode is energy efficient in delivering photons to catalyst surfaces. Nanomaterials are in a porous layer on the outside surface of the optoelectrode. This arrangement allows dissolved pollutants in water to diffuse in and out of the pores as the pollutants become oxidized at the photoanode.

Optical fibers are light waveguides that can be used for flexible optoelectronic functional integration, such as photodetectors, lasers, and biosensors. Light can be launched into optical fibers from concentrated sunlight, a light-emitting diode (LED), and lasers. Due at least in part to the photons and evanescent wave energy from within the fiber strikes the fiber's outer surface, placing nanomaterials on the fiber surface eliminates light transmittance losses through water or glass reactor windows, and achieves higher quantum yields. Additionally, the physical flexibility, ability to connect with a variety of light sources, and photon transmission efficiency make POFs suitable for complex designs and support photocatalysis by additional nanolayers in the solar spectrum.

Using pre-synthesized nanomaterials on optoelectrodes allow flexibility in catalyst choice and control of crystal lattice and other structures, while avoiding manufacturing steps (e.g., chemical or atmospheric deposition). The optoelectrode fiber can replace well-known glass electrodes by improving light harvesting and delivery to the photocatalyst on the POF surface, through side-emission of light from within the fiber lumen. This process reduces energy requirements and enhances reaction surface area. Optoelectrode fabrication allows for consideration of surface morphology of varying nanomaterials (e.g., ITO and ABI) and mass loadings on a high surface area POF, which influences light energy passing through the fiber, improving the side-emission and photon utilization. Each nanomaterial layer enhances photoelectrochemical (PEC) performance.

Incident photon-to-current efficiency effects of nanomaterial-Nafion®-PVDF POFs are quantified. Nano-enabled POF optoelectrode degradation of a model organic pollutant (e.g., benzoate ion) demonstrates competitive electrochemical advanced oxidation process application. A visible light catalyst ABI is benchmarked against TiO₂. Photoelectrocatalytic nanomaterial modified-POF are tested in POF optoelectrodes.

FIGS. 1A and 1B depict schematic illustrations of a reactor 100. The reactor 100 includes one or more coated optical fibers 102. Each coated optical fiber 102 includes a polymeric side-emitting optical fiber 104, a cladding 106, and a coating 108. The coating 108 contains a photocatalyst. The cladding 106 is disposed along a length of the polymeric side-emitting optical fiber 104 and is between the optical fiber 104 and the coating 108. The cladding 106 can be in direct contact with the optical fiber 104, the coating 108, or both. In some cases, an electrically conductive nanomaterial 110 is between the cladding 106 and the coating 108. The electrically conductive nanomaterial 110 can be in direct contact with the cladding 106, the coating 108, or both. The electrically conductive nanomaterial 110 can be in the form of electrically conductive nanoparticles. The electrically conductive nanoparticles have an average diameter of about 1000 nm or less (e.g., 1 nm to 1000 nm or any range therein, such as 1 nm to 200 nm, 50 nm to 150 nm, 100 nm to 500 nm, etc.).

In some cases, an ionomer-containing layer 112 is between the cladding 106 and the coating 108. The ionomer-containing layer 112 can be in direct contact with one or two of the cladding 106, the coating 108, and the electrically conductive nanomaterial 110. As depicted in FIG. 1A, the layers of the coated optical fiber from interior to exterior include polymeric side-emitting optical fiber 104, cladding 106, electrically conductive nanomaterial 110, ionomer-containing layer 112, and coating 108. In other implementations, the layers of the coated optical fiber from interior to exterior include polymeric side-emitting optical fiber 104, cladding 106, electrically conductive nanomaterial 110, and coating 108, or polymeric side-emitting optical fiber 104, cladding 106, and coating 108.

The polymeric side-emitting optical fiber 104 can include an acrylic polymer. In some cases, the acrylic polymer includes poly(methyl methacrylate). The cladding 106 can include a fluoropolymer. In one example, the fluoropolymer is polyvinylidene fluoride. In some cases, the coating 108 is porous. The photocatalyst can include a perovskite, titania, a modified strontium titanate, or any combination thereof. In some implementations, the perovskite includes TAB₃Bi₂Br₇I₂. The electrically conductive nanomaterial 110 can include indium tin oxide. The indium tin oxide is typically in the form of nanoparticles. In one example, the photocatalyst is embedded in the ionomer-containing layer 112. The ionomer-containing layer 112 can include a sulfonated tetrafluoroethylene-based fluoropolymer copolymer.

The reactor 100 can include one or more light sources 114, with each light source 114 optically coupled to at least one of the coated optical fibers 102. The light source 114 can include concentrated sunlight, a light-emitting diode, or a laser. Each light source 114 is configured to provide ultraviolet radiation to one or more of the coated optical fibers 102. The ultraviolet radiation can be selected to photo-induce exciton generation in the photocatalyst.

This disclosure also describes fabrication and characterization of a photocatalytic hydrogen production system that includes attaching a modified strontium titanate onto polymer optical fibers. FIG. 1C depicts a POF-strontium titanate (STO) system and the hydrogen production mechanism that occurs on the surface of the POF-STO system via water splitting. In one example, PMMA POFs are coated with a STO photocatalyst coating.

### EXAMPLES

### Example 1. A Polymeric Optical Fiber (POF)-Indium Tin Oxide (ITO)/TAB₃Bi₂Br₇I₂ Perovskite (ABI) or POF-ITO/Titania (TiO₂) Optoelectrodes

Tetrabutylammonium bromide (≥98%), tetrabutylammonium iodide (98%), bismuth bromide (≥98%), titanium dioxide (TiO₂, 99.5%), 4-chlorobenzoic acid (99%), acetone (99%), isopropanol (99%), sodium benzoate (99.95%), and sodium oxalate (Na₂C₂O₄, ≥99%) were supplied by Sigma-Aldrich. Sodium benzoate (99.95%), sodium oxalate (≥99%), Nafion® (5% w/w in water and 1-propanol), p-benzoquinone (pBQ, 98%), and tert-butanol (tBuOH, 99%) were obtained from Thermo Fisher Scientific. All the other chemicals were of analytical grade and were used directly with any purification.

Side-emitting polymeric optical fibers (Model: 3925FT 0.50NA) were purchased from Fiber Optic Products (UT, USA). The POFs of 1.5 mm diameter included a composite of two polymers: a poly(methyl methacrylate) (PMMA) core of 1470 μm diameter with refractive index of 1.49, and a polyvinylidene difluoride (PVDF) outer layer of 30 μm thick with refractive index of 1.43. The difference in refractive indices between the two polymers resulted in side-emission of light from the core of the fiber. POFs were cut into 30 cm lengths. Cut surfaces at both ends were polished using five optical polish films (e.g., LE30D, LE5P, LE3P, LE1P, LE03P, Thorlabs, Newton, NJ) until a specular surface was obtained. Polishing was conducted after cutting fibers and after modification of fibers with nanomaterials. The cut surfaces on both ends of bare and coated POFs had smooth surfaces for decreasing the interference when light is launched from the light-emitting diode (LED) into the lumens, which was defined as the fiber's inner region where the light is transmitted through.

PMMA/PVDF polymers are not intrinsically electrically conductive. Therefore, the POFs were modified to implement conductive properties at their interfacial surface. ITO is a semiconductor with optical transparency to visible light. ITO nanoparticles (e.g., 50 nm; 99.5% purity, US Research Nanomaterials Inc.) were used to coat POFs. ITO powder was homogeneously dispersed in 15 mL of acetone and ultrasonicated within a Branson M5800 ultrasound bath for 30 minutes. Acetone induces plasticization by chain disentanglement of the PVDF polymer layer which enables ITO nanoparticle attachment by enmeshment on the POF surface. The suspended solution was placed in a thin pipette-shaped cylindrical container, and the pristine POFs were submerged into the solution for 2 seconds and removed. The acetone was quickly evaporated under atmospheric conditions. Finally, the ITO coated POFs were rinsed with ultrapure water and fully dried at 60° C. for 1 hour. To achieve different mass loadings of ITO on the POF surface, ITO suspended acetone solutions were prepared containing different mass loading of nanoparticles ranging from 0.5 g L⁻¹ up to 10.0 g L⁻¹.

Optoelectrodes benefited from the use of ABI or TiO₂ photocatalysts. Optoelectrodes were manufactured following a dip coating method using a photocatalyst suspension. The dispersion solution included photocatalytic nanoparticles (e.g., TAB₃Bi₂Br₇I₂ perovskite or TiO₂) in 15 mL of isopropanol containing 10 wt % of ionomer Nafion®. To ensure homogenous dispersion, the solution was sonicated for an hour in an ice bath before use. Photoelectrocatalyst doses in the dispersion ranged from 3 g L⁻¹ up to 10 g L⁻¹. The POF-ITO fibers were dip coated in the selected solution for 2 seconds and air dried. Optoelectrodes were rinsed with ultrapure water and dried for 1 hour at 60° C. to yield POF-ITO/ABI and POF-ITO/TiO₂ optoelectrodes. Similar procedures were followed to prepare blank fibers by using pristine POF instead of POF-ITO obtaining POF-ABI and POF-TiO₂ fibers.

For comparison to POFs, commercial ITO glass plates (e.g., 3×1 cm⁻²; 100 nm ITO thick, Guluo China) were used as flat substrates for additional electrocatalyst characterization. The ITO glass electrodes were coated with ABI and TiO₂ following the same method described above for POF coatings.

The morphology and elemental composition of pristine and modified POF surfaces were assessed using a scanning electron microscope (e.g., JEOL JXA-8530F) coupled with energy dispersive X-ray spectroscopy. The crystallographic planes and structures were evaluated by X-ray diffraction. The diffractograms were registered on a Malvern PANalytical Aeris X-ray Diffractometer for fibers with Cu Kα radiation (λ=1.5406 Å) at a voltage of 40 kV and a current of 15 mA. The optical properties and band structure of ABI were obtained on an ultraviolet-visible spectrophotometer (e.g., Hitachi U-4100) and ultraviolet photoelectron spectroscopy was used to identify the adsorption wavelengths and valence band maximum.

The optical light transmittance and refraction optical properties for side-emission of the POF and modified POF were evaluated through photon irradiance measurements. Optoelectrodes and pristine POFs were mounted on monochromatic ultraviolet LEDs (e.g., λ=395 nm) of 2.18 W set at 3.48 V and irradiance of 29 μW cm⁻². Light output in terms of irradiance (μW cm⁻²) was measured by a spectrophotoradiometer (e.g., Avantes AvaSpec-2048 L (Louisville, CO)).

Electrochemical and photoelectrochemical (PEC) characterizations were conducted using a potentiostat (Autolab PGSTAT302N from Metrohm (USA)) operated with Nova 2.1.1 software. Electroanalytical characterizations were carried out in a three-electrode system including a platinum wire as counter electrode, Ag/AgCl as the reference electrode, and different working electrodes of 1 cm²geometric area: POF-ITO, POF-ITO/ABI and POF-ITO/TiO₂. Ultrapure water solutions containing 1.0 M Na₂SO₄ as supporting electrolyte at pH 6.8 deaerated with nitrogen gas were used in all the photochemical and photoelectrochemical characterization measurements. The irradiation source used in photo-assisted experiments included the same ultraviolet LEDs (λ=395 nm) of 2.18 W with a spectral width of 40 nm in 120 radiation angles. Cyclic voltametric and linear sweep voltammetry analyses were recorded in the potential range of 0.0 V to 1.2 V vs. Ag/AgCl with a scan rate of 5 mV s⁻¹ in the dark or under light irradiation. Photocurrent density stability was studied by operating chronoamperometry measurements at an applied potential of 1.2 V vs. Ag/AgCl with an on/off irradiation cycles of 60 seconds each.

Incident photon-to-current efficiency measurements evaluated the ratio of the photocurrent versus the rate of incident photons as a function of wavelength. The incident photon-to-current efficiency values were estimated under a constant potential bias of 1.2 V versus a reversible hydrogen electrode following equation (1):

$$IPCE ( \% ) = \frac{{J}_{ph} \times 1239.8}{{I}_{input} \times λ} \times 100 \qquad ( 1 )$$

where Jₚₕ (mA cm⁻²) is the obtained photocurrent density at the specific incident-light wavelength (λ, nm), 1239.8 (V×nm) is the constant via Planck's constant (h) multiplied by speed of light (c), and Iᵢₙₚᵤₜ is the irradiance of the monochromatic LED.

The competitiveness of the optoelectrodes to be applied in electrochemical advanced oxidation processes was assessed through the photoelectrocatalytic degradation of the benzoate ion. A batch reactor including a cylindrical electrochemical cell containing 50 mL of 261 M sodium benzoate solution and 0.5 M Na₂SO₄electrolyte at pH 6.8 was used. Solutions were kept under vigorous stirring at 350 revolutions per minute to ensure transport from and towards the optoelectrode during treatment. The optoelectrodes were operated with a monochromatic ultraviolet LEDs (λ=395 nm) of 2.18 W set at 3.48 V and irradiance of 29 μW cm⁻². The same set-up was used to conduct blank experiments of photocatalysis (without application of a bias potential) and electrocatalysis (without ultraviolet-light irradiation). Aliquots of the solution were collected over time and the benzoate ion was quantified by chromatographic analyses of high-performance liquid chromatography (e.g., Waters 2695) coupled to a photodiode array detector (e.g., Waters 2998) set at 225 nm. The high-performance liquid chromatography system was fitted with a Waters LiChrosorb 10 μm column (e.g., diameter: 4.0 mm; length: 25 cm). Separation was conducted using a mobile phase with a 70:30 ratio of water to acetonitrile at 25° C. with a flow rate of 1.0 mL min⁻¹. The injection volume was 10 μL. Chromatograms illustrated well-defined peaks of benzoate at retention times of 2.1 minutes. Degradation kinetics in benzoate ion (InC) over time (Cₜ) showed fittings for pseudo-first order rate kinetics. The percentage of benzoate degradation was quantified from equation (2):

$$Removal ( \% ) = \frac{{C}_{t} - {C}_{t = 0}}{{C}_{t = 0}} \times 100 \qquad ( 2 )$$

Reactive oxygen species assessments were performed in the presence of appropriate radical scavenging compounds, including sodium oxalate (Na₂C₂O₄) for holes, p-benzoquinone for superoxide radicals, and tert-butanol for hydroxyl radicals to determine the reactive species and electrons' or holes' redox reaction in the PEC degradation of benzoate ion addition.

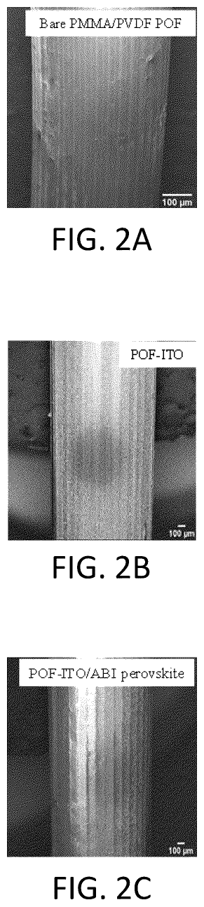

Electron microscopy images were obtained for the exterior surface and elemental mapping of uncoated POF, POF-ITO and POF-ITO/ABI. Referring to FIG. 2A, the surface of the uncoated bare POF contains carbon, oxygen and fluorine, which include the PVDF POF cladding. After the dip-coating of ITO, the POF-ITO exhibited a uniform thin deposited layer containing indium and tin distributed on the fiber surface, as shown in FIG. 2B. The POF-ITO/ABI optoelectrode exhibited a homogenous coverage with bismuth, bromine, and iodine, as shown in FIG. 2C. After cleaving the POF-ITO/ABI optoelectrode, successful deposition of nanomaterials evenly distributed along the outside surface of POFs was confirmed.

X-ray diffractograms of POF-ITO for different mass loadings confirmed the presence of characteristic peaks of ITO thin film on the optical fibers at 21.7°, 30.8°, 35.7°, and 51.9° 20 that are associated to the (211), (222), (400), and (440) planes of crystalline ITO. This suggested that the ITO dip-coating fabrication retained original crystallinity without any peak shifting. Likewise, after decorating ABI onto the POF-ITO, the X-ray diffraction pattern exhibited additional peaks at 25.2° and 51.7° 2θ belonging to the (006) and (0012) crystal plane, which corresponded to the c-directional growth of perovskite structure. Moreover, a strong peak signal of ABI was detected at 32.1° suggesting the presence of (210) plane of cubic perovskite in A₃B₂X₉ formation, which resulted from the fixed atomic positions of indium in the tetragonal phase. Scanning electron microscopy, energy dispersive X-ray spectroscopy, and X-ray diffraction analyses confirmed the fabrication of modified cladding and surface on the bare POF via dip-coating without changes in nanomaterial crystalline structures, demonstrating stability on the POF.

POFs side-emit light at 395 nm due at least in part to differences between refractive indices of the PMMA core (refractive index (n)=1.49) and 30 μm thick PVDF coating (n=1.43). Due at least in part to the smooth and evenly textured outer surface, the bare POF has a low intensity of side-emitted light along the 30 cm length (e.g., 1230 μW cm⁻² maximum at the proximal end and 36 μW cm⁻² at the terminal end); this provided a baseline value for side-emitted energy light.

The side-emission of light was enhanced by integrating of nanomaterials into the PVDF layer. Compared to the bare POF, the addition of a thin ITO layer (e.g., mass loading of 8 μg ITO cm⁻¹ fiber) on the POF resulted in a slight enhancement of side-emission from 1230 to 1620 μW cm⁻². This can be attributed to changes in the refractive index of the coating; the ITO serving as additional scattering centers; and evanescent wave interactions between the ITO nanomaterials and fiber interface. An ITO loading of 73 μg cm⁻¹ resulted in the largest side-emission, approximately 7 times higher than the side-emission of the bare fiber. The side-emission decreased exponentially from a maximum of 8120 μW cm⁻² at the proximal end of the modified POF to 230 μW cm⁻² at the terminal end.

The side-emitted light allowed the nanomaterials within the PVDF coating of the POF to be excited, leading to photon-driven reactions. The measurement of side-emitted light represented the excess light that is not efficiently harvested and instead served as an indicator of increased photon delivery to nanomaterials within the PVDF/Nafion® interlayer. This increased photon delivery allowed for more efficient absorption and utilization of the light as it passes through the catalyst layers. Overall, incorporating ITO materials into or onto the PVDF surface increased the side-emission performance. This improvement can be attributed to the transparent property (≥85%) and the ability of the transparent property to extend light absorption (e.g., ultraviolet-to-visible light spectrum) of ITO nanomaterials.

Coating ABI on POFs resulted in greater enhancements of side-emitted light than an ITO coating, which displayed approximately 1.4-fold improvement in the similar mass loading of nanomaterials. For example, POF-ABI with a 60 μg cm⁻¹ loading (5 g ABI L⁻¹) exhibited higher side-emitted light profiles than POF-ITO with a mass loading of 61 μg cm⁻¹. These side-emission results suggested that the size or composition of nanomaterials, which influences refractive indexes and overall light scattering behaviors, can have a larger impact than particle mass loading in the PVDF layer.

Efficient optoelectrode operation can involve more than high levels of side-emitted light. For example, the choice of materials can impact interfacial layer conductance and visible light photoactivity. Therefore, to create a fiber with both photoactive and conductive properties, two types of nanomaterials were incorporated into the surface of the POF. Increasing mass loadings of ABI to 10 μg cm⁻¹ on POF-ITO with 65 μg cm⁻¹ leads to a 6-fold enhancement in side-emission at the proximal end from 1830 μW cm⁻² to 11700 μW cm⁻². Based on a comparison between the two modified optical fibers, the deposition of the second layer of photocatalysts improved the side-emitted light through the dual-layer of nanomaterials.

An energy balance on light throughout the fiber provided insights into the efficiency of POFs. The overall light input entering the optical fiber (I₀) was distributed according to equation (3), where I₀ (μW cm⁻²) was measured with bare POF using a 2-cm length fiber. I_{T} (μW cm⁻²) measured the irradiance on the bottom surface of the fiber, which is transmitted through the fiber to the tip (e.g., the light escaping from the bottom of the fiber). The value of I_{Abs} (%) signified the portion of entering light absorbed by the polymer layers (e.g., PMMA and PVDF layer) and was calculated using equation (4), with I_{S}, I_{T}, and I_{U} (e.g., I_{U} equals zero (%) in bare POF since no nanomaterials deposited on the bare POF) subtracted from I₀ in uncoated POF. To quantitatively compare the total amount of side emitted light along the length of the fiber relative to light entering the fiber, the I_{S} and I_{U} (%) were calculated by following equation (5) and (6), respectively,

$${I}_{0} = {I}_{s} + {I}_{U} + {I}_{T} + {I}_{A b s} \qquad ( 3 )$$

$${I}_{A b s} ( \% ) = \frac{{I}_{0} - {I}_{T} - {I}_{S} - {I}_{U}}{{I}_{0}} \times 100 \% \qquad ( 4 )$$

$${I}_{s} ( \% ) = \frac{{\int }_{0}^{L} {I}_{s} d L}{{I}_{0}} \times 100 \% \qquad ( 5 )$$

$${I}_{U} = \frac{{I}_{0} - {I}_{S} - {I}_{T} - {I}_{A b s}}{{I}_{0}} \times 100 \% \qquad ( 6 )$$

where I_{S} is the irradiance scattered by the various refractive indices in the multiple nanomaterial layers, calculated as the integrated three-dimensional irradiation “cone” of the energy side emitted along an equivalent length (e.g., 30 cm) of the cylindrical-shaped POF, where I₀ (W cm⁻²) is the light energy entering the fiber and I_{U} is the irradiance absorbed or utilized by the photoelectrocatalytic layer, calculated by subtracting the other three parameters from I₀.

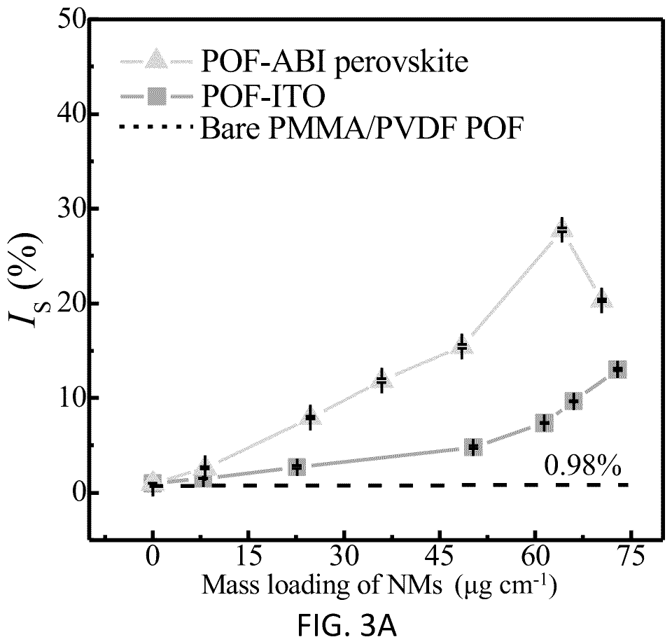

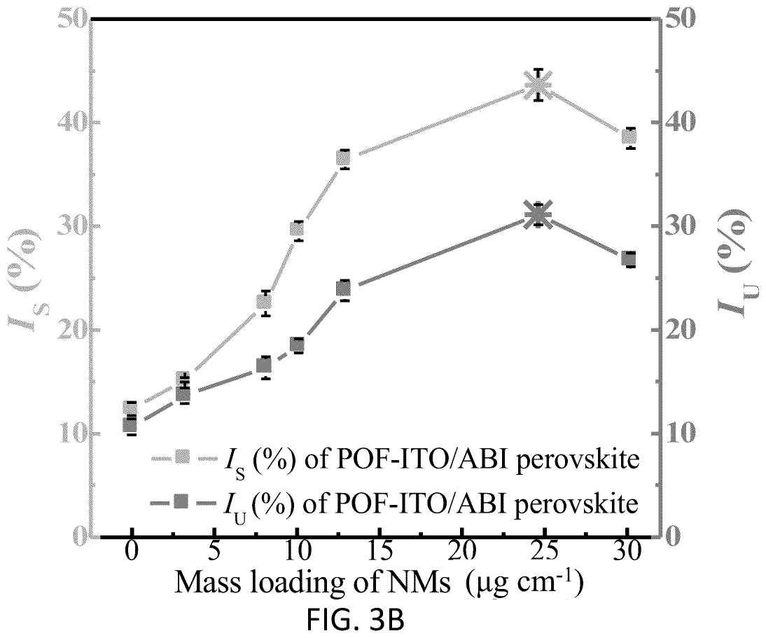

A higher side-emission efficiency is desirable, at least in part because a higher side-emission efficiency assures photoactivation of nanomaterials throughout the POF surface layer. FIG. 3A shows side-emission efficiency increased to 13% when prepared with higher nanomaterials mass loading of ITO (e.g., 73 μg cm⁻¹). Comparable side-emission efficiencies were observed for single nanomaterial coating (e.g., ITO alone or ABI alone), where the POF-ABI (67 μg cm⁻¹) displays an increase in side-emission efficiency, which is approximately 2.1 times higher than POF-ITO (73 μg cm⁻¹). However, a 20% decrease in side-emission efficiency was observed when the mass loading of ABI increased to 70 μg cm⁻¹. The 20% decrease in side-emission efficiency is due at least in part to an excessive amount of nanomaterials or aggregation of nanomaterials within the POF surface layer, or both. This can cause obstruction or scatting of light back into the lumen.

The mass loading of ABI was adjusted to maximize the side-emitted light of the POF-ITO/ABI, which would increase photoexcitation of the nanomaterials on the POF surface. FIG. 3B shows a gradual increase in side-emission efficiency to 44% for POF-ITO/ABI up to 17 g cm⁻¹ mass loading of perovskite, followed by a slight decrease in side-emission efficiency to 39% for the higher mass loading of ABI (e.g., 30 μg cm⁻¹). The highest side-emission efficiency occurred when two layers of nanomaterials (e.g., ITO and ABI) were coated onto the POFs. Using these coatings (e.g., 68 μg cm⁻¹ ITO and 25 μg cm⁻¹ ABI with Nafion®), the number of coating cycles utilized to achieve homogeneous deposition of photocatalytic layers on POF-ITO was assessed.

The highest side-emission efficiency (e.g., 58%) was achieved with three coating cycles using a solution with 75 μg cm⁻¹ of ITO and 25 μg cm⁻¹ of ABI. Based on the performance in terms of side-emission efficiency, this modified POF was further assessed and used in subsequent calculation of the light utilization efficiency based upon equation (6). The light utilization efficiency increased to 11% and 16% with the deposition of 73 μg cm⁻¹ of ITO nanomaterials and 67 μg cm⁻¹ of ABI on the POF.

In FIG. 3B, the highest light utilization efficiency was achieved using a dual-nanomaterial coating with the first ITO layer with a mass loading of 75 μg cm⁻¹ followed by an ABI layer with a mass loading of 25 μg cm⁻¹ in three layers. Both ITO nanomaterials and ABI utilize light in the PVDF layer through absorption, reaction, scattering, or any combination thereof. This can lead to an improvement in side-emission efficiency and light utilization efficiency. The dual nanomaterial layer of ITO and ABI increased side-emitted light on the fiber surface, enhancing the absorption or utilization capability between the photocatalyst layers and incident or scattered light.

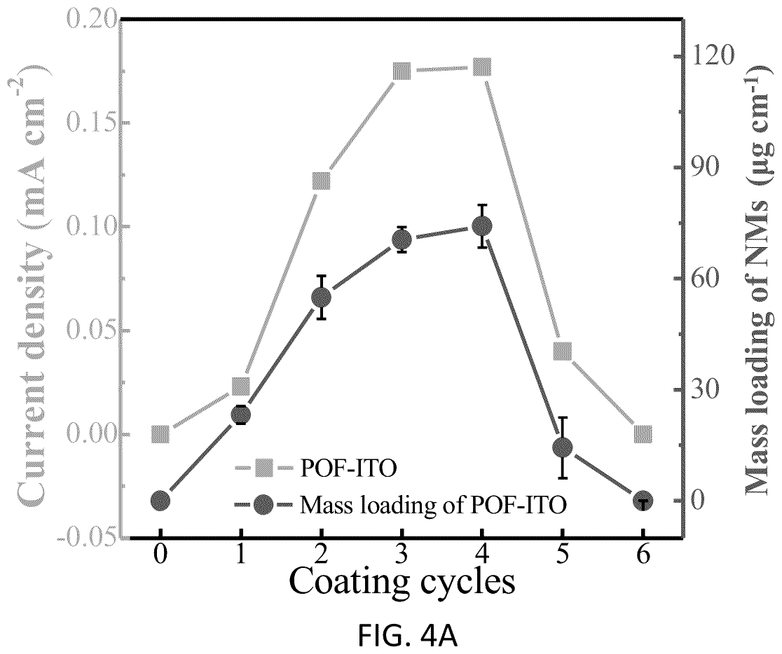

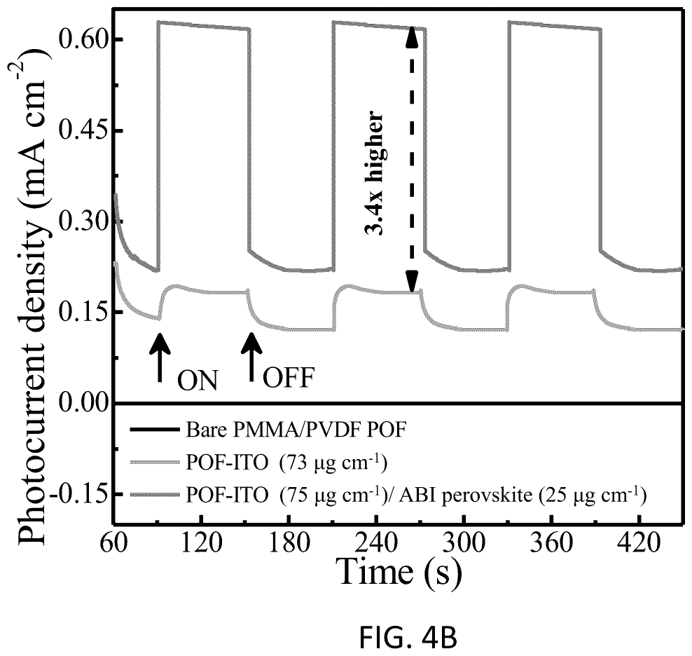

To assess if ex-situ synthesized ITO nanomaterials coated into the PVDF layer of the POF can create a photo-anode, the impact of ITO coatings on the ability of polymer fibers to conduct electricity (e.g., applied potential at 0.0-1.2 V vs Ag/AgCl) in the absence of light within the reactor containing a 0.5 M Na₂SO₄ electrolyte solution was assessed. FIG. 4A shows linear sweep voltammetry current density measurements for a bare POF and six different POF-ITO, fabricated through multiple coating cycles using a 10 μg ITO L⁻¹ acetone solution. There was no measurable current density for the bare POF, which included a non-conductive PMMA fiber core and a PVDF coating. POF-ITO with three or four coating cycles achieved the highest current density of 0.18 mA cm⁻² with a 71 μg ITO cm⁻¹ and 74 μg ITO cm⁻¹ mass loading, respectively. However, increasing the ITO loading through additional acetone-based nanomaterial solution coating cycles did not increase current density, as shown in FIG. 4A. Excessive coating cycles caused near complete dissolution of the PVDF layer, leading to a loss of conductivity. The ITO loading in POF-ITO decreased to 14 μg cm⁻¹ after five cycles and disappeared in the sixth cycle of coating. These results confirmed the capability of ITO nanomaterials to create electroconductive POFs via multiple optimized coating cycles. Furthermore, the current response stability of a conductive optoelectrode, the robustness of the POF-ITO with a mass loading of 73 μg cm⁻¹ through ten successive electrochemical experiments with an applied potential of 1.2 V vs. Ag/AgCl was assessed. The electrical-conductivity performance remained relatively stable throughout the ten repeated cycles, with a consistent current density in a range of 0.18 mA cm⁻² to 0.17 mA cm⁻².

Photo-conductivity of POF-ITO/ABI quantified using cyclic voltammetry and linear sweep voltammetry analyses with different mass loadings of ABI on the POF-ITO surface. Perovskites provide several optical and electronic advantages (e.g., high catalytic activity, tunable redox property, and light absorption ability), which can increase electrical conductivity and photocurrent response under electrocatalysis and photoelectrocatalysis, respectively. The highest current density of 0.66 mA cm⁻² was achieved for POF-ITO (75 μg cm⁻¹)/ABI (25 μg cm⁻¹), which was 10% higher than the ABI-ITO glass plate in the well-known optoelectrode configuration.

FIG. 4B shows that the modified optoelectrode has an enhanced photocurrent density for the dual-nanomaterial coated POFs by the chronoamperometry experiment at an applied potential of 1.2 V vs. Ag/AgCl. Additionally, the current response recorded under dark conditions corresponded to the pure electrochemical response of the polarized optoelectrode with the same bias potential above. The photocurrent density was approximately 3.5 times higher for the mass loadings of 75 μg cm⁻¹ ITO with 25 μg cm⁻¹ ABI compared to the photocurrent density of only ITO. This improvement played a role in advancing the integration of light-driven photocatalysts within the integrated optoelectrode fiber system. This integration facilitated excitation through visible light irradiation, leading to the production of photo-excited electrons. Subsequently, these electrons were propelled by a positive electric field from the POF-ITO/ABI anode towards the cathode, enhancing the conductivity response. The stable photocurrent observed over multiple cycles with the LED on, and minimal response without light, can be attributed at least to the integrated optoelectrode facilitating electron migration on the surface of POF-ITO/ABI. Photocurrent measurements on both the pristine POF and the POF included 1000 cycles of flexible electrodes bending at an angle of 120°. The current density performance remained consistently high, approaching 100% for both optoelectrode fibers. This demonstrated the structural durability of the POF electrodes, even after enduring repeated physical bending. The PEC analysis highlighted the synergistic and tunable nature of using both ITO and ABI nanomaterials on the surface of POFs to improve charge transfer efficiency. However, ABI is not the only candidate that can function as a PEC system.

The POF-ITO platform's robustness was demonstrated by comparing the photocatalytic response of ABI against commercial TiO₂. The POF-ITO/TiO₂ with 75 μg ITO cm⁻¹ and 21 μg TiO₂ cm⁻¹ achieved a photocurrent density of 0.55 mA cm⁻². This response was a slightly lower response than for the POF-ITO/ABI optoelectrode with similar nanomaterial loadings of 75 μg ABI cm⁻¹ and 25 μg ABI cm⁻¹. This result demonstrated the flexible nature of POFs to embed various types of photocatalysts. Therefore, selecting the appropriate catalyst can help optimize the photoelectrocatalytic response driven by visible-light irradiation.

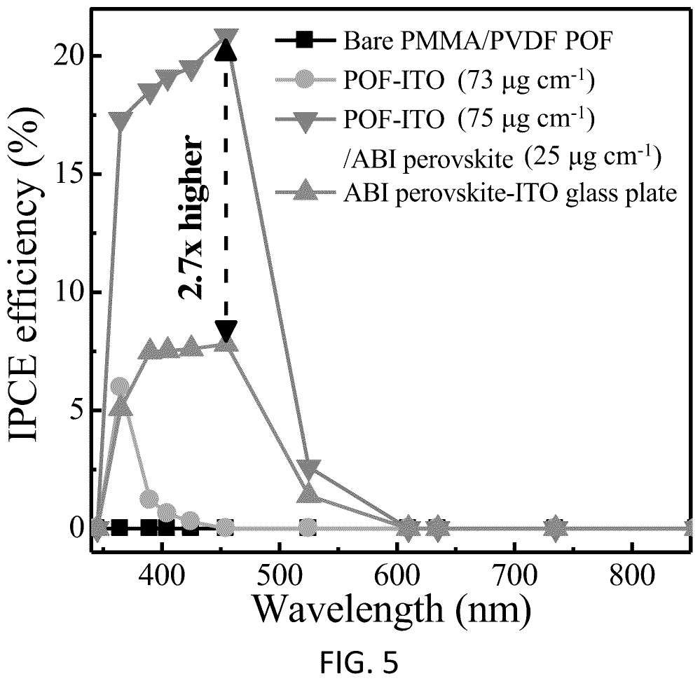

The incident photon-to-current efficiency value provided insights into the performance of the PEC system from ultraviolet to visible wavelengths. FIG. 5 shows the incident photon-to-current efficiency results for the bare POF, POF-ITO, and POF-ITO/ABI coatings under various incident monochromatic lights. The bare POF demonstrated negligible incident photon-to-current efficiency, indicating an inability to conduct a current (e.g., applied potential at 1.2 V vs. Ag/AgCl). At a wavelength of 340 to 410 nm, the incident photon-to-current efficiency of the POF-ITO coating with a mass loading of 73 μg cm⁻¹ only increased slightly by 6%. However, when 25 μg cm⁻¹ of ABI was added to the POF-ITO coating, the incident photon-to-current efficiency increased to 21%, which is approximately 3.2 times higher than that of the POF-ITO coating. The data also showed that for the POF-ITO/ABI optoelectrode, the incident photon-to-current efficiency responding wavelengths were extended up to 550 nm. This improvement can be attributed at least in part to ABI's visible-light response, which enhances the conversion rates between photons and current.

The modified optoelectrode and a well-known glass plate were both loaded with equal ABI mass loadings of approximately 23 μg cm⁻¹ and incident photon-to-current efficiency measurements were assessed. As shown in FIG. 5, the POF-ITO/ABI optoelectrode exhibited nearly 300% higher efficiency than the ABI-ITO glass plate due at least in part to the improved reactive capability of the nanoparticles deposited on the fiber surface. These results highlighted the performance of the dual-coated POFs as optoelectrodes across a wide spectrum, with improved light-harvesting capability that enhanced the interaction between photons and current.

Photoelectrochemical POF optoelectrodes possessed the capability to enhance electron-hole pairs separation and effectively prevent recombination. Even though the relevance of the superoxide radical pathway decreased due at least in part to charge carrier separation by the electrical field, this process further enhanced the formation of the stronger oxidant, the hydroxyl radical, for transforming organic pollutants in water. POF optoelectrodes generated reactive oxygen species to transform organic pollutants in water. The benzoate ion served as a model for other pollutants due at least in part to a well-established oxidation mechanism via reactive oxygen species. The PEC-POF platform of 75 μg ITO cm⁻¹ and 25 μg ABI cm⁻¹ achieved 92% benzoate degradation in 60 minutes, with a pseudo first-order degradation rate constant (k) of 9.7×10−4 s⁻¹. POF-ITO with ABI demonstrated a 250% higher k value than ITO alone, indicating more efficient light energy and reactive oxygen species utilization. Additionally, POF-ITO with ABI showed an approximately 1.4 times higher k value than when coated with 21 μg cm⁻¹ of TiO₂, highlighting the superior photocatalytic ability of ABI over TiO₂ due at least in part to a broader absorption wavelength from ultraviolet to visible light, making the ABI over TiO₂ easily photoactivated by the 395 nm LED.

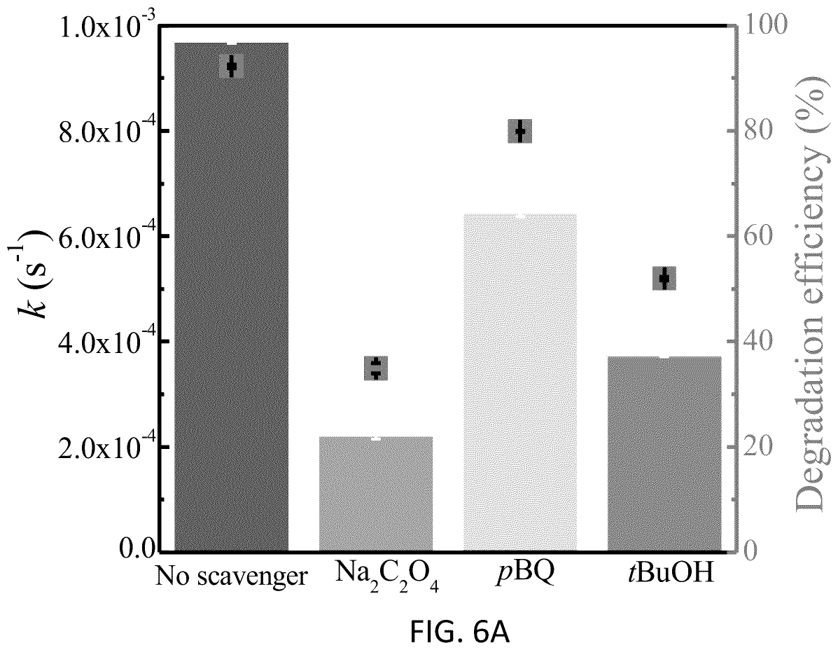

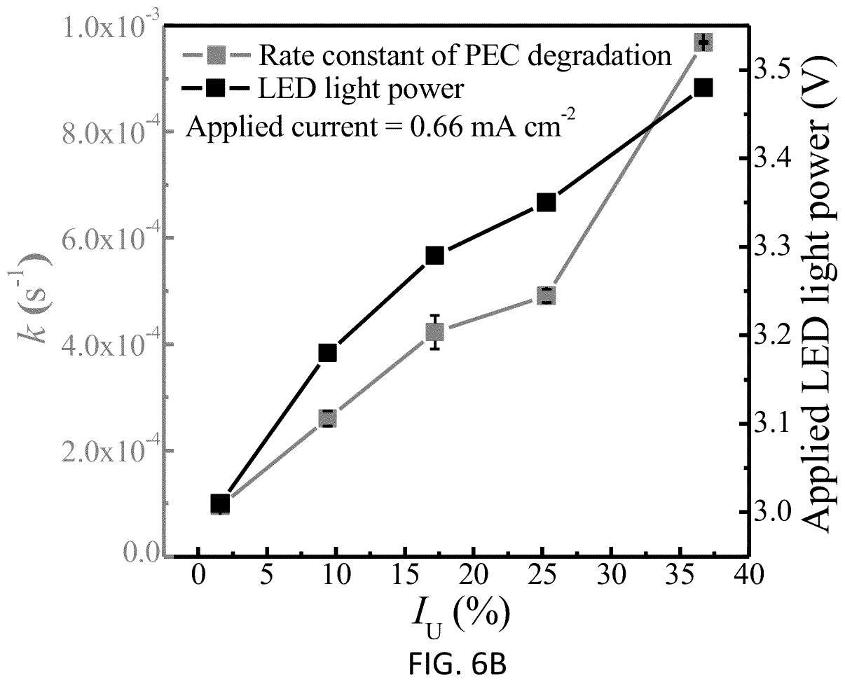

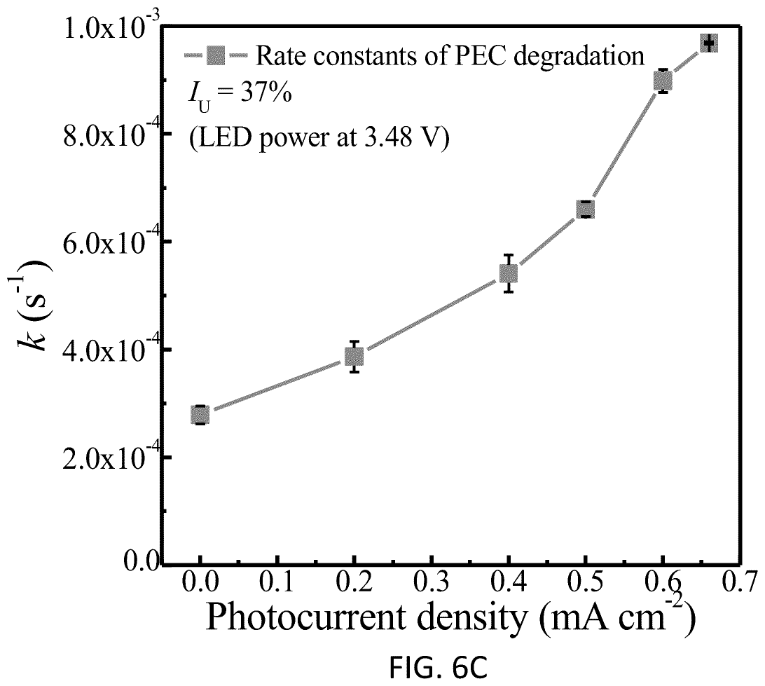

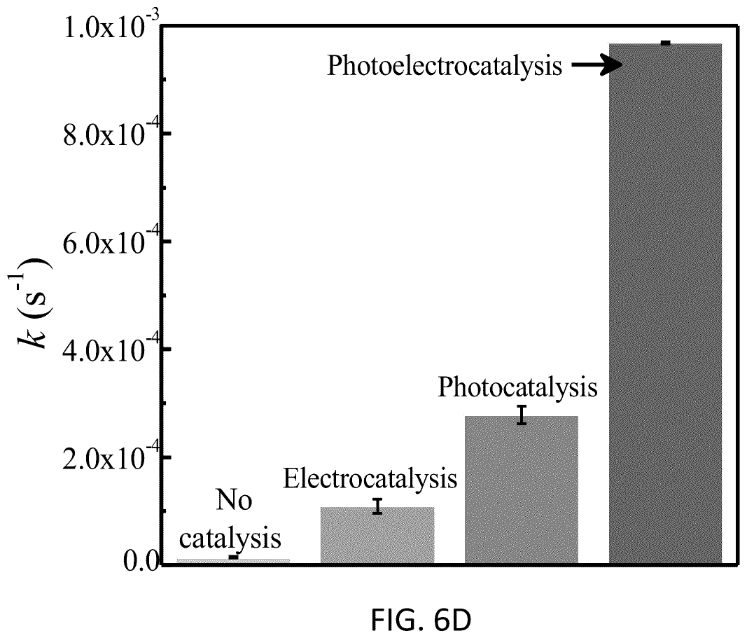

To assess if the reactive oxygen species (h⁺, —O₂⁻, and —OH) are the primary agents responsible for the degradation of benzoate ion, common radical quenching agents (e.g., Na₂C₂O₄, p-benzoquinone, and tert-butanol) were added during the experiments. FIG. 6A shows that the addition of 0.01 mol L⁻¹ Na₂C₂O₄, p-benzoquinone, and tert-butanol resulted in a decrease of 35%, 80%, and 52% benzoate ion concentrations after 60 minutes, respectively. The k was observed to decrease by a factor of approximately 1.3 to 4.5 in the presence of a scavenger, compared to experiments conducted without a scavenger (k=9.7×10⁻⁴ s⁻¹). Reactive oxygen species scavenger findings indicated that h⁺ and —OH are the main reactive oxygen species reacting with the benzoate ion in the PEC reaction, with —O₂-simultaneously assisting in accelerating the destructed process. These results demonstrated the mechanisms that occur within the porous polymer-nanomaterial coating of the PEC-POF system.

The nanomaterial-Nafion®-PVDF coating allowed solutes, reactive oxygen species, or any combination thereof to permeate the active nanomaterial polymer layer. Negligible benzoate ion adsorption occurred in control experiments, suggesting diffusion into the POF coating and reactions or reactive oxygen species diffusion to degrade the pollutant.

The PEC experiment controlled the same applied potential of 1.2 V vs. Ag/AgCl in electrocatalysis, and variable light intensities were produced by adjusting the power level from 3.01 to 3.48 V of the 395 nm LED. FIG. 6B demonstrated that increasing power resulted in higher light utilization efficiency, and consequently higher k values. The highest degradation rate (k=9.7×10⁻⁴ s⁻¹) was achieved with 37% light utilization efficiency using the low powered LED power of 3.48 V. These results suggested that higher light intensity enhanced the photoreaction response, as the higher light intensity accelerated the redox reaction of electrons and holes by promoting the separation of electron-hole pairs.

To maintain a constant light delivery (e.g., 3.48 V to the LED to achieve 37% light utilization efficiency), the current density was intentionally varied from 0.0 mA cm⁻² to 0.6 mA cm⁻² with an applied potential ranging from 0.4 to 1.0 V vs. Ag/AgCl. FIG. 6C shows minimal benzoate ion removal (k=2.7×10−4 s⁻¹) at 0.0 mA cm⁻², whereas applying currents up to 0.6 mA cm⁻² improved the benzoate ion removal achieving higher k value (maximum k=9×10⁻⁴ s⁻¹). The ability to degrade a low molecular weight solute (e.g., benzoate ion) highlighted the porous nature of the nanomaterial-Nafion®-PVDF layer. The porosity of this layer played a role for the electrolyte, enabling photo-current within the optoelectrode. Salt ions diffused within the porous layer, facilitating electrocatalysis within the modified POF and accelerating electron migration, thus reducing recombination rates for enhancing the generation of reactive oxygen species within the photocatalyst.

FIG. 6D shows that there was negligible benzoate ion removal (k=1.5×10⁻⁵ s⁻¹) in a control experiment with neither light nor electric current. Parallel assessments were conducted using a POT-ITO/ABI in current-only (no light), light-only (photocatalysis), or PEC mode (light and current). In the PEC mode, the degradation performance was improved compared to photocatalysis or applied current alone. With a current density of 0.66 mA cm⁻² and a light intensity of 37% light utilization efficiency, the PEC system removed 68% of the benzoate after 60 minutes (k=2.8×10−4 s⁻¹). FIG. 6D shows the best performance was achieved in the PEC mode (k=9×10⁻⁴ s⁻¹) following the same mechanism with photocatalysis, indicating the synergistic effect of both photocatalysis and applied current to enhance the generated carriers and electron migration efficiently, minimizing recombination impacts while degrading the pollutant.

To further assess the degradation capabilities of the POF-ITO/ABI optoelectrode, the target pollutant was replaced with organic dyes (e.g., methyl blue and methyl orange). These dyes were chosen to investigate their degradability and the resulting color changes after photoelectrocatalysis. The rate constant of methyl blue (k=2.2×10−3 s⁻¹) and methyl orange (k=1.2×10−3 s⁻¹) under photoelectrocatalysis was more than 2 times higher than the photocatalytic degradation. Both organic dyes exhibited near complete removal reaching approximately 100% and resulted in colorless solutions after 60 minutes of PEC experiments. This result demonstrated the versatility of the optoelectrode fiber in degradation applications while also highlighting its performance in integrating photocatalysis and electrochemistry.

Benzoate ion oxidation using the POF-ITO/ABI optoelectrode as a PEC system with an applied potential of 1.2 V vs. Ag/AgCl (e.g., irradiated by 2.18 W LED) was performed multiple times, repeating the experiments with the same optical fiber and replacing the test solution between runs. There was approximately 92% benzoate ion degradation after 60 minutes across all five individual experiments and the k values for benzoate ion were similar (p=0.44). This result indicated that the PEC-POF system is stable and does not decompose over time.

### Example 2. POF-Strontium Titanate (STO) System

Modified STO, detailed as RhCrCoOx-deposited on aluminum-doped strontium titanate (SrTiO₃:Al), was synthesized using a well-known method. SrTiO₃:Al was synthesized by doping Al³⁺ into SrTiO₃ in a SrCl₂ flux. During the synthesis, SrCl₂ (Kanto Chemicals Co., Inc., 98.0%, anhydrous), Al₂O₃(Sigma-Aldrich Co, LLC., nanopowder), and SrTiO₃ (Wako Pure Chemicals Industries, Ltd., 99.9%) were mixed in a 10:0.02:1 molar ratio by grinding in an agate mortar. The mixture was then annealed in an alumina crucible at 1,423 K for 10 hours in air and subsequently allowed to cool to room temperature. To remove unreacted SrCl₂, the product was washed with distilled water and retrieved by filtration. This process was repeated several times until the supernatant solution reached a neutral pH. Finally, the resulting SrTiO₃:Al was dried at 313 K in an oven. Then, the cocatalyst RhCrCoOₓ was loaded on SrTiO₃:Al by impregnation in an aqueous solution of RhCl₃·6H₂O (Wako Pure Chemical Industries), K₂CrO₄ (Kanto Chemical Co.), and Co(NO₃)₂·6H₂O (Kanto Chemical Co.) followed by calcination in air. 0.4 g of SrTiO₃:Al was first dispersed in 2 ml of distilled water with sonication and stirring. Then, freshly prepared precursor solutions with 0.1 wt % of rhodium, 0.1 wt % of chromium, and 0.1 wt % of cobalt with respect to the Al:SrTiO₃ mass were added to the SrTiO₃:Al suspension. The solution was evaporated in a water bath with stirring. The resulting powder was collected and calcined at 350° C. for 1 hour with a heating rate of 10° C. min⁻¹.

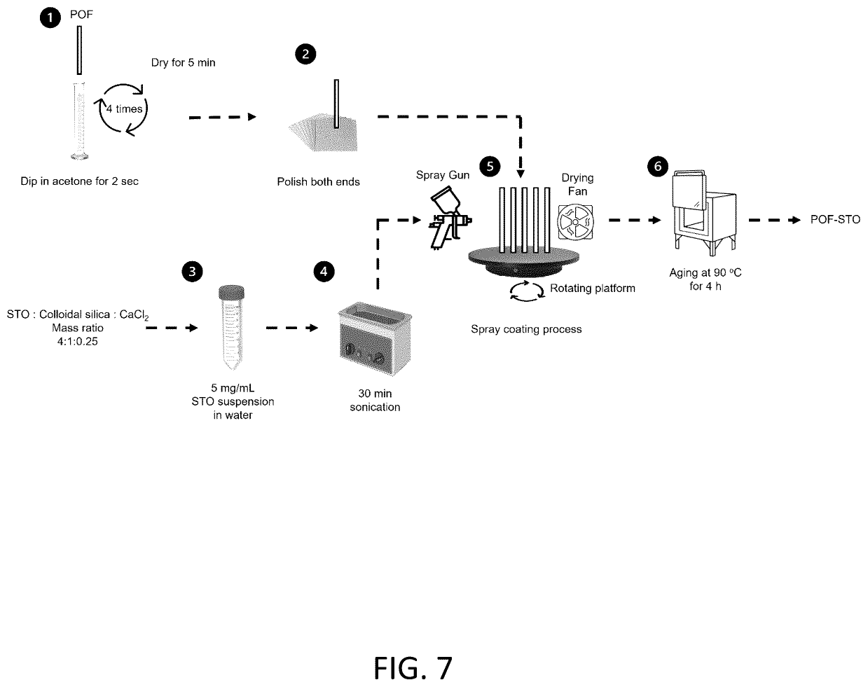

FIG. 7 depicts an example procedure of the fabrication of POF-STO samples. The POF surface etching was performed to enhance side-emission light and increase surface roughness for STO deposition. POFs (e.g., 3 mm in diameter) with a PMMA core with fluorinated polymer cladding were obtained from Industrial Fiber Optics Inc. (Model Eaka™ CK-120). Each fiber was cut into 16 cm lengths and cleaned using isopropanol (>99%, Sigma Aldrich). POF surface etching was performed by dipping pre-cleaned POF in acetone (≥99.5%, Sigma-Aldrich) for 2 seconds, rapidly pulling it out, and drying at room temperature. This dipping and drying process was repeated four times. The raw surfaces at both ends of each POF were polished using five grades of optical polish paper (e.g., LE30D, LE5P, LE3P, LE1P, and LE03P, Thorlabs™) until a smooth, mirror-like finish was achieved.

A STO suspension was prepared by dispersing a chained colloidal silica binder (Nissan Chemical Inc. Model number ST-OUP) and calcium chloride (VWR, Catalog No.0556) in 50 ml of ultrapure water at a 4:1:0.25 mass ratio of STO to colloidal silica to calcium chloride. The STO concentration was 5 mg mL⁻¹. The suspension was sonicated in a water bath (Branson M5800) for 30 minutes. During the spray coating process, five etched POFs were placed vertically on a rotating platform, with a drying fan positioned on the right side of the platform, maintained at a temperature of 65° C. to 70° C. The suspension was sprayed using a manual sprayer (e.g., Gocheer™ Airbrush Kit Model 101-BMC) from the left side of the rotating platform with different sprayed amounts ranging from 10 mL to 50 mL. The resulting POF samples were dried at 90° C. for 4 hours to obtain the POF-STO samples. After the drying step, the POF-STO samples were washed by isopropanol to wash away unattached STO and dried in 60° C. for 1 hour.

The scanning electron microscopy and energy dispersive X-ray spectroscopy analysis of bare POF, etched POF, and POF-STO was performed using a Zeiss Auriga FIB-SEM. The X-ray diffraction of POF-STO was measured using a Rigaku SmartLab High Resolution X-ray Diffractometer. The Fourier transform infrared spectroscopy data were obtained using a PerkinElmer Frontier FTIR.

The optical properties of bare POF, etched POF, and POF-STO were evaluated through photon irradiance measurements, including the total light input entering the POF at the proximal end (I₀), the side-emitted light due at least to scattering per each 1 cm of the POF, and the transmitted light irradiance through the distal end (I_{T}). Light irradiance (μW cm⁻²) was measured by a spectrophotoradiometer (e.g., Avantes AvaSpec-2048 L). The strontium loading on the POFs was quantified using an inductively coupled plasma-mass spectrometer (ICP-MS, e.g., Perkin Elmer Inc., NexION 2000) after full extraction and digestion of the fiber samples. A 2 cm fiber sample was cut and placed into a 55 mL MARSXpress TFM vessel with 10 mL of a nitric acid and hydrogen peroxide mixture in a 9:1 ratio and left to extract overnight. The samples were then digested using a MARS5 microwave oven from CEM Corporation with the following settings: Power, 1600 W (75%); ramp time, 5 minutes; temperature, 100° C.; hold time, 5 minutes; ramp time, 5 minutes; temperature, 160° C.; hold time, 20 minutes. The samples were then diluted with Milli-Q water to a final volume of 50 mL. All samples were further filtered through a 0.22 μm filter (e.g., Cole-Parmer® Catalog No. 384-2216-CP) to remove undigested materials and diluted with Milli-Q water and 2% nitric acid to achieve concentrations within the target calibration range of 1 to 1,000 parts per billion while maintaining a nitric acid concentration of 1.5 to 2.5% (v/v).

The hydrogen evolution reaction was conducted in the glass cylinder reactor. During the reaction, the reactor was placed vertically, with the STO-POF and a 5 W monochromatic ultraviolet light-emitting diode (λ=365 nm, operating at 0.7 A and 3.2 V, Shenzhen Yunju Electronics Co., Ltd.) positioned at the bottom of the reactor. Meanwhile, hydrogen gas samples were taken from the top of the reactor every 30 minutes and quantified using by gas chromatograph (e.g., Shimadzu GC 2010) using a thermal conductivity detector set at 200° C. and a Carboxen 1010 PLOT column (e.g., 30 m, 0.53 μm diameter) maintained isothermally at 230° C. Ultra-high purity argon (>99.999%) served as the carrier gas at a flow rate of 40 mL min-. Calibration for hydrogen quantification was achieved by analyzing standard H₂ concentrations (e.g., 0%, 10%, 20%, 40%, 80%, 100% H₂ in a 200 μL H₂-N₂ mixture), with a linear integrated area-H₂ concentration relationship.

The performance of the POF-STO system was also assessed in different water chemistries: ultrapure water, acidic environments, alkaline environments, tap water, and artificial seawater. The ultrapure water was generated using a Thermo Scientific™ Barnstead™ GenPure™ water purification system. The acidic environments were prepared using two acidic solutions with a pH of 4: one with hydrochloric acid solution (e.g., Fisher Chemical, Catalog No. A508-4) and another with a buffer solution prepared from potassium hydrogen phthalate (e.g., Sigma Aldrich, Product No. 179922) and hydrochloric acid. The alkaline environments were prepared using two alkaline solutions with a pH of 11: one with sodium hydroxide solution (e.g., BDH, Product No. BDH9292) and another with a buffer solution prepared from sodium hydrogen phosphate (e.g., Alfa Aesar, Product No. 11592) and sodium hydroxide. The tap water was taken directly from Building A at the Biodesign Institute, Arizona State University (Tempe, AZ) without further treatment. The artificial seawater was prepared by dissolving 500 g of sea salt (e.g., Red Sea™) in 1 L of ultrapure water and mixing vigorously.

In the multiple POF experiment, two or three fibers were bundled together using a 3D-printed bundle holder. The bundle holder was created by a 3D printer (e.g., Prusa™ Model No. S11S Speed) and utilized in the POF-STO system in the same manner as the single fiber setup. For the 40° C. operation, the ultrapure water was preheated to 40° C. in a water bath before being filled into the reactor. A heating tape (e.g., BriskHeat™ Model HSTAT101004) was wrapped around the reactor during the experiment to maintain a consistent temperature of 40° C.

X-ray diffraction measurements demonstrated the crystalline structure of STO on the POF. The diffraction pattern of POF-STO exhibited several peaks corresponding to the (100), (110), (111), (200), (210), (211), and (220) crystal planes. These peaks indicated no adverse transformation of STO during and after the deposition on the POF surface. Fourier transform infrared spectroscopy spectra of bare POF, solvent etched POF, and POF-STO further supported these results. The presence of C—F and F—C—F bonds confirmed the fluorinated polymer cladding on bare POF. Negligible differences in Fourier transform infrared spectroscopy spectra between bare and etched POF samples suggested that the mild solvent etching process did not alter the chemical structure of the cladding. For the POF-STO sample, in addition to the C—F and F—C—F peaks of POF itself, new Fourier transform infrared spectroscopy spectra peaks were observed at 1088 cm⁻¹, corresponding to Si—O—Si vibrations of colloidal silica (as the STO binder), and at 557 cm¹, characteristic of the Sr—Ti—O bond, and confirm the deposition of STO.

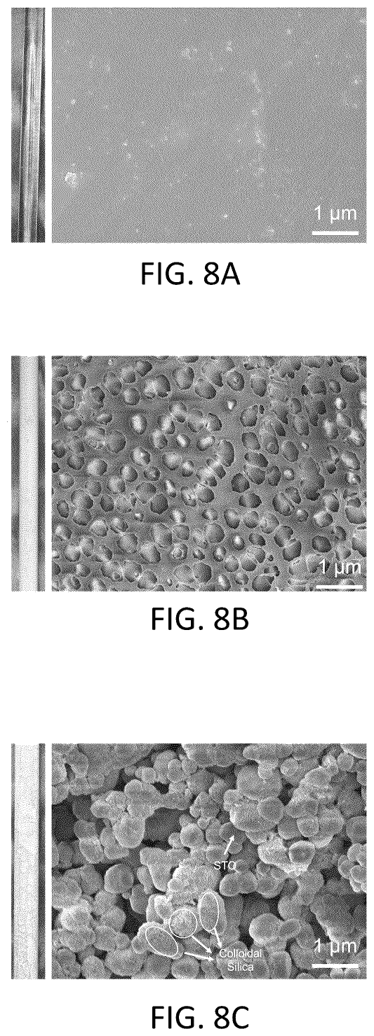

The morphology of POF-STO was characterized by scanning electron microscopy and energy dispersive X-ray spectroscopy. FIGS. 8A-8C show the scanning electron microscopy images of bare POF, solvent etched POF, and POF-STO samples. The bare POF, as shown in FIG. 8A, has a smooth surface, whereas the etched POF, as shown in FIG. 8B, exhibits a porous structure with pore sizes less than approximately 1 μm. FIG. 8C reveal the presence of aggregated STO and colloidal silica deposited on both the surface and within the pores of etched POF. Comparing the scanning electron microscopy images of STO powder and the POF-STO surface, the distribution of colloidal silica, which serves as a binder to aid STO deposition on the POF surface, can be identified.

Scanning electron microscopy with energy dispersive X-ray spectroscopy element mapping of POF-STO confirmed the presence of strontium and titanium, indicating the deposition of STO. The presence of rhodium, chromium, and cobalt indicated the inclusion of cocatalysts on STO. The presence of silica suggested the use of chained colloidal silica as catalyst binders on the POF surface. The detection of fluorine on the surfaces represented the fluorinated polymer cladding.

The porous structure of POF can improve STO catalytic activity and H₂ production of the POF-STO system at least in part because it enhances STO attachment and deposition, improves the light side-emission of POF, and permits diffusion of small molecules (e.g., H₂O, H₂, O₂) to and from the catalyst surface. Under different preparation conditions, STO mass loadings on the POF varied from 94 to 520 μg Sr cm⁻¹. STO loadings increased with the amount of STO suspension sprayed onto the POF. Identical catalyst coating conditions with and without solvent etching pretreatments were compared. The solvent etching pretreatment included spraying 40 mL of the 5 mg mL⁻¹ STO solution. With the solvent etching pretreatment, STO loadings of 420 pg Sr cm⁻¹ was achieved, whereas STO loadings of 239 μg Sr cm⁻¹ was achieved without it. The solvent etching process provided an approximately 50% enhancement in STO loading compared to a non-treated bare POF. This finding indicated that the porous structure created by pre-etching plays a role in improving the STO loading on the POF.

The porous structure of POF created by solvent etching enhanced side-emitting light, which provided more photons for H₂ production. Side-emission occurred due at least in part to differences in refractive indices between the PMMA core and fluorinated polymer coating. Additionally, side-emission occurred due at least in part to surface imperfections which can cause surface scattering or evanescent wave interactions with particles within the POF cladding. Side-emission of light created a glow-stick like feature, where light from within the POF lumen exited the POF core, irradiated the STO in the POF cladding, and was utilized to photoexcite the STO (e.g., light utilization efficiency). Some light also exited the POF cladding as measurable side-emitted light. While side-emitted light was not utilized by the catalyst, higher intensities can lead to greater catalyst photo-excitation. The bare POF facilitated side-emission; however, its intensity decreased along the length of the POF and the bare POF retained only approximately 400 μW cm⁻² at the distal end (e.g., 16 cm). In comparison, the etching procedure enhanced the POF's side-emission intensity, particularly at the proximal end. Both etched POF and STO-coated etched POFs exhibited a 2 to 2.5-fold increase at the proximal end, and at the distal end, they maintained 500-800 μW cm⁻², which is 25% to 100% higher than bare POF. This enhancement was attributed at least in part to changes in surface roughness and the introduction of additional scattering centers. The STO material in the POF cladding was continuously photo-excited and this was unlike a photocatalyst slurry system where light shading, scattering and varying intensities can occur.

A comparison of POFs with different STO loadings demonstrated that the etched POF had a side-emission efficiency value of 9%, which is approximately 2.5 times higher than that of the bare fiber, indicating that the porous POF-STO design optimized light delivery. The deposition of STO slightly reduced side-emission efficiency, due at least in part to light absorption and utilization by STO. Meanwhile, the light utilization efficiency increased with the increasing deposition of STO, reaching a maximum light utilization efficiency value of 16% at a 420 pg Sr cm⁻² loading. Calculations also showed that more than 16% of the incident light energy and more than 21% of the incident light energy was absorbed. This led to decaying side-emission during light transmission within the POF and energy loss.

The photocatalytic H₂ generation over two hours with different STO loadings showed linear regressions, suggesting zero-order kinetics. H₂ generation rates increased with STO loading up to 420 μg Sr cm⁻¹, where it reached a maximum hydrogen production rate of 69 μmol h⁻¹. A STO loading of 520 μg Sr cm⁻¹ showed a 40% lower H₂ generation rate than for a STO loading of 420 μg Sr cm⁻¹, suggesting that thick or dense photocatalyst layers on POFs hinder performance. A thicker STO layer can limit the access of H₂O molecules or light to the STO within the cladding. These results were also consistent with the light utilization efficiency of POF-STO, where the highest light utilization efficiency of 16% corresponded to the optimized hydrogen production rate of 69 μmol h⁻¹. Shorter (e.g., 2 hours) versus longer (e.g., 12 hours) duration performance of the STO-loaded POF with 420 μg Sr cm⁻¹ was compared. The 12-hour performance showed the same sustained H₂ production rate, suggesting the stability of STO within the POF cladding.

The photocatalytic (PC) versus PEC H₂ generation rates (mol h⁻¹) at different catalyst loadings (mg cm⁻¹) for the POF-STO system and the POF-ITO/g-C₃N₄ system was compared. Catalyst loadings were calculated using the atomic percentages of strontium and nitrogen in STO and g-C₃N₄, respectively. In addition to the increase in H₂ production, the PC POF-STO system simplified the reactor design, as shown in FIG. 1C. The PC POF-STO did not include a potentiostat and electrodes with a continuously applied bias potential. Furthermore, the PC system did not deposit ITO to generate a photocurrent in the optoelectrode. The PC POF-STO system did not include a high electrolyte in solution. The absence of the high electrolyte in solution (e.g. 0.2 M Na₂SO₄) led to the use of the system in a variety of water environments. For example, tap water and seawater could be used without further treatment and was less likely to cause oxidation reactions at the anode in PEC systems. This flexibility allowed the system adaptable to a wide range of operational conditions.

H₂ production rates between the same PC system using a POF-STO and an STO slurry was compared. The STO was suspended in the same PC reactor with a bare POF connected to a light-emitting diode providing the light, instead of the STO being deposited on the POF surface. The results showed that STO attached to the POF has approximately a 23-fold improvement in H₂ production rate compared to STO mixed in solution as a slurry, highlighting the advanced design of the nanocatalyst-embedded POF. The inside-out light delivery mechanism of the POF-STO system allowed close confinement of photons and evanescent wave energy at the POF's surface to activate the deposited nano-catalyst. This enhanced light delivery and photocatalyst efficiency, eliminating the light energy losses typically seen with light transmission through glassware walls and electrolytes in well-known slurry and panel designs.

The quantum efficiency (%) between the PC (POF-STO) and PEC optoelectrode (POF-ITO/g-C₃N₄) reactor designs was compared. POF-STO showed approximately a 2.5-fold improvement in quantum efficiency compared to the PEC optoelectrode design, indicating higher efficiency of light conversion to H₂ in the POF-STO system. This difference can be attributed at least to side-emitting light intensity loss during delivery along the 16 cm of the POF, with a reduction in light intensity (>90%) within the first 8 cm from the proximal end.

In addition to ultrapure water, the impact of the pH with ion composition and concentrations on the photocatalytic POF-STO system was assessed, including complex water chemistries present in local tap water or seawater.

The POF-STO system demonstrated stable hydrogen production in both acidic and alkaline environments, indicating its robustness and adaptability. In acidic conditions, while the high proton concentration (H⁺) theoretically enhanced the reduction reactions at the STO surface leading to efficient hydrogen production, the POF-STO system remained stable as shown in equation (7).

$$2 {H}^{+} + 2 {e}^{-} \to {H}_{2} \qquad ( 7 )$$

This stability suggested that the STO photocatalyst effectively managed the available protons without oversaturation or recombination losses. In alkaline environments, hydroxide ions (OH⁻) are oxidized by the photogenerated holes to produce oxygen gas and water, as shown in equation (8):

$$4 {OH}^{-} \to 2 {H}_{2} O + {O}_{2} + 4 {e}^{-} \qquad ( 8 )$$

Referring to equation (9), these electrons generated from the reaction contributed to the reduction of protons to produce hydrogen:

$$2 {H}_{2} O + 2 {e}^{-} \to {H}_{2} + 2 {OH}^{-} \qquad ( 9 )$$

The stability of the POF-STO system in different pH environments can be attributed to the robust nature of the STO photocatalyst, which maintained its structural integrity and catalytic activity under varying acidic and basic conditions. Additionally, there was negligible impact on the polymer cladding within which the STO resides. The inside-out light delivery mechanism of the POF-STO system remained stable and efficient across different pH conditions.

There was a slight decline (e.g., 10-15%) of hydrogen generation in tap water and artificial seawater compared to ultrapure water. This reduction can be attributed to the presence of various impurities and ions in these water sources. For example, chloride and carbonate ions can negatively impact photocatalytic hydrogen generation. Chloride ions can compete with water molecules for interaction with the photogenerated charge carriers, reducing the hydrogen production rate. Meanwhile, carbonate ions can adsorb onto the surface of the photocatalyst, blocking active sites and reducing overall photocatalytic efficiency.

Despite this reduction, the POF-ITO system maintained relatively high performance, indicating its robustness and adaptability. Cocatalyst deposition on STO can help mitigate some of the negative effects of these impurities. The polymer cladding within which the STO is embedded can also help preclude ions (e.g., hinder their diffusion from bulk solution) larger in size than H⁺ or OH⁻.

In some implementations, multiple fibers can be bundled together to increase the hydrogen production rate. Hydrogen production of the same reactor system and LED supply integrating one fiber, two fibers, and three fibers bundled together was studied. Three fibers provided about 60% more H₂ production rate than a single fiber. This suggested that multiple fibers can capture more light compared to a single fiber, increasing the overall light utilization surface area. This can lead to more photons being available to excite the photocatalyst, thereby enhancing the hydrogen production rate.

A design utilizing a bundle with more than 50 fibers integrated with an LED array containing up to 100 individual LED chips on its core surface was constructed. This configuration further amplified hydrogen production. Additionally, fabricating bundles of POF-STO allowed for the increase the irradiated surface area while maintaining low packing geometry requirements for a large-scale reactor. This resulted in a high geometric packing density (e.g., m² catalyst surface area per m³ reactor volume), which led to an efficient physical footprint usage. In one example, a bundle of 30 POF-STO was integrated in a tubular reactor (e.g., 3 cm diameter, 16 cm length). This configuration achieved a geometric packing density of 664 m² m⁻³, which was approximately a 6.5-fold increase than that of a well-known PEC reactor utilizing a plate-shaped electrode or a PC-immobilized panel reactor.

Higher water temperatures can reduce the recombination rate of electron-hole pairs. Lower recombination rates can indicate that more charge carriers are available to drive the water-splitting reaction. H₂ production rates of the POF-STO system was assessed at different temperatures. The 40° C. water environment provided a 50% enhancement of H₂ production rates compared to the production rates at room temperature (e.g., 25° C.).

The POF-STO system can utilize various light sources, including solar light. In one example, a solar concentrator was used to capture and concentrate solar light. A liquid filter was installed between the solar concentrator and the POF-STO system to reduce the thermal energy transferred to prevent the system break-down. In another example, solar panels and energy storage systems were utilized to supply artificial light for the POF-STO system. Solar irradiation of a single POF-STO in a glass reactor with a reflective solar concentrator was assessed, which achieved a sustained hydrogen production over 2 hours.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A coated optical fiber comprising:
a polymeric side-emitting optical fiber;
a cladding along a length of the polymeric side-emitting optical fiber;
an electrically conductive nanomaterial in contact with the cladding; and
a coating over the cladding, wherein the coating comprises a photocatalyst.

2. The coated optical fiber of claim 1, wherein the polymeric side-emitting optical fiber comprises an acrylic polymer.

3. The coated optical fiber of claim 2, wherein the acrylic polymer comprises poly(methyl methacrylate).

4. The coated optical fiber of claim 1, wherein the cladding comprises a fluoropolymer.

5. The coated optical fiber of claim 4, wherein the fluoropolymer comprises polyvinylidene fluoride.

6. The coated optical fiber of claim 1, wherein the electrically conductive material comprises indium tin oxide.

7. The coated optical fiber of claim 1, wherein the electrically conductive nanomaterial is in the form of nanoparticles.

8. The coated optical fiber of claim 1, wherein the coating is porous.

9. The coated optical fiber of claim 1, wherein the photocatalyst comprises a perovskite.

10. The coated optical fiber of claim 9, wherein the perovskite comprises tris(tetramethylammonium bromide) dibismuth heptabromo diioide.

11. The optical fiber of claim 1, wherein the photocatalyst comprises titania.

12. The optical fiber of claim 1, wherein the photocatalyst comprises a modified strontium titanate.

13. The optical fiber of claim 1, wherein the photocatalyst is embedded in an ionomer.

14. The optical fiber of claim 13, wherein the ionomer comprises a sulfonated tetrafluoroethylene-based fluoropolymer copolymer.

15. A reactor comprising:
one or more of the optical fibers of claim 1; and
one or more light sources, each one of the one or more light sources optically coupled to at least one of the one or more of the optical fibers.

16. The reactor of claim 15, wherein the light source comprises concentrated sunlight, a light-emitting diode, or a laser.

17. The reactor of claim 15, wherein the light source is configured to provide ultraviolet radiation to the at least one of the one or more of the optical fibers.

18. The reactor of claim 17, wherein the ultraviolet radiation is selected to photo-induce exciton generation in the photocatalyst.

19. A method of making the coated optical fiber of claim 1, the method comprising:
polishing a polymeric side-emitting optical fiber; and
coating the polymeric side-emitting optical fiber with a mixture comprising a photocatalyst.

20. A method of treating organic pollutants, the method comprising:
contacting one or more of the coated optical fibers of claim 1 with an aqueous solution comprising an organic pollutant;
irradiating the photocatalyst with a light source, thereby generating reactive oxygen species; and
oxidizing the organic pollutant with the reactive oxygen species.
